(19) United States
(12) Patent Application Publication
(10) Pub. No.: US 2021/0038451 A1
(43) Pub. Date: Feb. 11, 2021

(54) Electric wheelchair DYYJBHD20

(71) Applicant: NANJING JIN BAI HE MEDICAL APPARATUS CO. LTD, Nanjing City (CN)

(72) Inventor: Zhaowei WANG, Nanjing City (CN)

(21) Appl. No.: 16/827,201

(22) Filed: Mar. 23, 2020

(30) Foreign Application Priority Data
Aug. 9, 2019 (CN) 201910733570.4

(51) Int. Cl. A61G 5/08; A61G 5/04; A61G 5/12

(52) U.S. Cl. CPC A61G 5/0866; A61G 5/0883; A61G 5/0891; A61G 5/122; A61G 5/125; A61G 5/128; A61G 5/047

(57) ABSTRACT

The invention discloses an electric wheelchair DYYJBHD20, which belongs to the technical field of medical equipment, and includes a backrest tube. The backrest tube is provided on a seat assembly. Armrest components are provided on the left and right sides of the backrest tube. On the seat assembly, the front end of the seat assembly is connected to the front wheel through a front fork connection assembly, and the rear end of the seat assembly is connected to the rear wheel through a rear frame. A matching foot pedal is provided at the front fork connection assembly, and at the rear wheel Used with auxiliary wheels. As a new structural design, the electric wheelchair DYYJBHD20 has a small folding volume and light weight, and uses the latest material, carbon fiber, which is very convenient to optimize the appearance of the entire vehicle. At the same time, the density of the carbon fiber material is about ⅓ of aluminium alloy, greatly reducing the weight of the entire vehicle.

### TECHNICAL FIELD

The invention belongs to the technical field of medical equipment, and particularly relates to an electric wheelchair DYYJBHD20.

### DESCRIPTION OF RELATED ART

Electric wheelchairs are mainly used for electric-powered scooters, which can move forward, backward, and turn, and can be used indoors and outdoors, which is easy and convenient to operate.

At present, in the wheelchair market, most foldable wheelchairs have complicated structures and complicated welding accessories, which adds a lot of difficulty to processing and assembly processes. At the same time, it also increases the weight of the entire vehicle and affects the optimization of the overall appearance of the vehicle.

### SUMMARY OF THE INVENTION

### Object of the Invention

The object of the present invention is to provide an electric wheelchair DYYJBHD20. The device has a simple and compact structure, and has a smaller volume after being folded.

### Technical Solution

In order to achieve the above-mentioned object of the invention, the present invention adopts the following technical solution:

The electric wheelchair DYYJBHD20 includes a backrest tube. The backrest tube is provided on the seat assembly. Armrest assemblies are provided on the left and right sides of the backrest tube, and each armrest assembly is fixed to the seat assembly through an armrest support sheet. The front end of the seat assembly is connected to the front wheel through a front fork connection assembly, the rear end of the seat assembly is connected to the rear wheel through a rear frame, and a cooperative pedal is provided at the front fork connection assembly. An auxiliary wheel is used at the rear wheel.

Further, the seat assembly is connected to the motor fixing bracket through a second rotation shaft, and the motor fixing bracket is connected to the rear frame through a first rotation shaft.

Further, the rear frame is connected to the left connecting piece and the right connecting piece respectively through a third rotating shaft, and the rear frame is connected to the backrest tube through a fourth rotating shaft.

Further, the backrest tube, the rear frame, the left connecting piece, the right connecting piece, the seat component, the motor fixing bracket, the armrest component, the armrest support piece, the front fork connection component, and the pedal are all made of carbon fiber.

Further, the backrest tube is connected to the seat assembly through a fifth rotation shaft, the backrest tube is connected to the armrest component through a sixth rotation shaft; the armrest support piece is connected to the armrest component through a seventh rotation shaft, and the armrest support piece is connected to the seat component through an eighth rotation shaft.

Further, the front fork connection assembly is connected to the seat assembly through a ninth rotation shaft, and the front fork connection assembly is connected to the left connection piece and the right connection piece respectively through a tenth rotation shaft.

Further, the foot pedal is connected to the front fork connection component through a twelfth rotation shaft to realize upside down of the foot pedal.

Further, a cooperative handle lock and a limit screw are provided on the seat component, and the handle lock is connected to the seat component through the eleventh rotation shaft to realize up and down rotation, and the limit screw is used to achieve locking. Or unlock.

Beneficial effect: Compared with the prior art, the seat cushion and the backrest tube of the electric wheelchair DYYJBHD20 of the present invention participate in the folding process. After the folding is completed, the volume of the electric wheelchair DYYJBHD20 after being folded is 0.14 cubic meters, which is greatly smaller than other old models; the process is smooth, and the device has a simple and compact structure, which realizes easy folding, and is also convenient to carry.

### BRIEF DESCRIPTION OF THE DRAWINGS

FIG. 1 is a schematic structural diagram of an electric wheelchair DYYJBHD20;

FIG. 2 is a schematic diagram of a folded front link structure;

FIG. 3 is a simplified schematic diagram of the connecting rod of FIG. 2;

FIG. 4 is a schematic structural view of a Part A of the electric wheelchair DYYJBHD20 before folding;

FIG. 5 is a structural schematic diagram of Part A during the folding process of the electric wheelchair DYYJBHD20;

FIG. 6 is a schematic diagram of the folding process of the electric wheelchair DYYJBHD20;

FIG. 7 is a schematic structural diagram of the folded electric wheelchair DYYJBHD20;

Reference numerals: 1—backrest tube, 2—rear frame, 3—left connecting piece, 4—right connecting piece, 5—seat component, 6—motor fixing bracket, 7—armrest component, 8—armrest support piece, 9—fork connection assembly, 10—foot pedal, 11—front wheel, 12—rear wheel, 13—handle lock, 14—auxiliary wheel, 15—limit screw, 16—armrest buckle, 17—first rotation shaft, 18—second rotation shaft, 19—third rotation shaft, 20—fourth rotation shaft, 21—fifth rotation shaft, 22—sixth rotation shaft, 23—seventh rotation shaft, 24—eighth rotation shaft, 25—ninth rotation shaft, 26—The tenth rotation shaft, 27—the eleventh rotation shaft, 28—the twelfth rotation shaft.

### DETAILED DESCRIPTION OF THE INVENTION

The invention is further described below with reference to the drawings and specific embodiments.

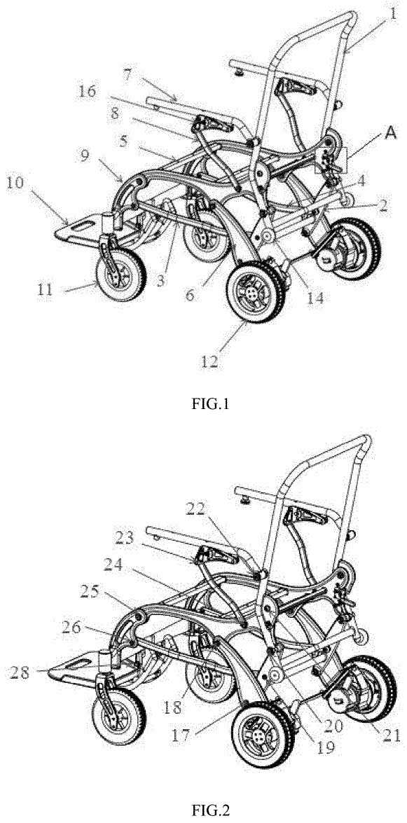

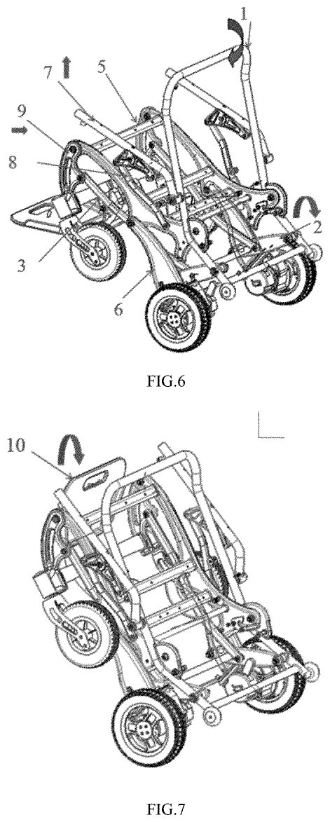

As shown in FIG. 1-7, the electric wheelchair DYYJBHD20 includes a backrest tube 1, a rear frame 2, a left connecting piece 3, a right connecting piece 4, a seat component 5, a motor fixing bracket 6, an armrest component 7, an armrest supporting piece 8, front fork connection assembly 9, foot pedal 10, front wheel 11, rear wheel 12, handle lock 13, auxiliary wheel 14, limit screw 15, armrest buckle 16. Among them, the backrest tube 1, the rear frame 2, the left connecting piece 3, the right connecting piece 4, the seat component 5, the motor fixing bracket 6, the armrest component 7, the armrest supporting piece 8, the front fork connection component 9, and the foot pedal 10 are made of carbon fiber.

The backrest tube 1 is provided on the seat assembly 5, and armrest assemblies 7 are provided on the left and right sides of the backrest tube 1. Each armrest assembly 7 is fixed to the seat assembly 5 through an armrest supporting piece 8, respectively, and the front end of the seat assembly 5 is connected with the front wheel 11 through a front fork connection assembly 9, and the rear end of the seat assembly 5 is connected to the rear wheel 12 through a rear frame 2. A foot pedal 10 is provided at the front fork connection assembly 9 for cooperation, and auxiliary wheels 14 is provided at the rear wheel 12 for cooperation.

The motor fixing bracket 6 is connected to the rear frame 2 and the seat assembly 5 through the first rotating shaft 17 and the second rotating shaft 18, respectively. The rear frame 2 is connected to the left connecting piece 3 and the right connecting piece 4 through the third rotating shaft 19, and the rear frame 2 is connected to the backrest tube 1 through a fourth rotation shaft 20; the backrest tube 1 is connected to the seat assembly 5 through a fifth rotation shaft 21; the backrest tube 1 is connected to the armrest component 7 through a sixth rotation shaft 22; the armrest support piece 8 is connected to the armrest component 7 through a seventh rotation shaft 23. The armrest support piece 8 is connected to the seat assembly 5 through an eighth rotating shaft 24, the armrest assembly 7 and the armrest buckle 16 fixed by two points, which can be regarded as a whole.

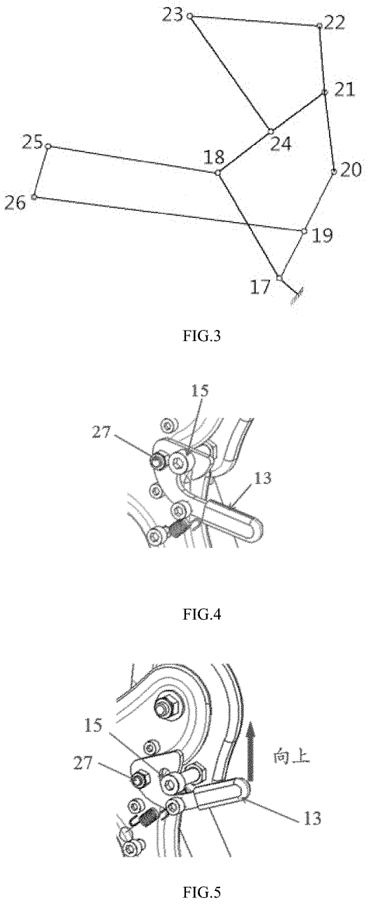

The front fork connection assembly 9 is connected to the seat assembly 5 through a ninth rotation shaft 25, and the front fork connection assembly 9 is connected to the left connection piece 3 and the right connection piece 4 through the tenth rotation shaft 26; The linkage logical relationship between the backrest tube 1, the rear frame 2, the left connection piece 3, the seat assembly 5, the motor fixed bracket 6, the armrest assembly 7, the armrest support sheet 8, the front fork connection assembly 9 was shown in FIG. 3. The foot pedal 10 is connected to the front fork connection assembly 9 through the twelfth rotation shaft 28 to realize the foot pedal 10 flip up and down; the handle lock 13 is connected to the seat assembly 5 through the eleventh rotation shaft 27 to achieve vertical rotation, and to achieve locking or unlocking through the limit screw 15.

Folding process: As shown in FIG. 3-7, the handle lock 13 is lifted up around the eleventh rotation shaft 27, so that the handle lock 13 is released from the limit screw 15 and then the backrest tube 1 is pushed. And then the frame 2 rotates backward around the first rotation shaft 17, the armrest assembly 7 rotates upward around the seventh rotation shaft 23, the armrest support piece 8 rotates downward around the eighth rotation shaft 24, and the front fork connection assembly 9 rotated backward around the ninth rotation shaft 25 via the left connection piece 3. The seat assembly 5 is rotated downward around the rear frame 2, and finally the frame is folded, and the foot pedal 10 is folded upward around the twelfth rotation shaft 28.

1. The electric wheelchair DYYJBHD20 is characterized in that it includes a backrest tube, the backrest tube is arranged on the seat assembly, and armrest assembly are arranged on the left and right sides of the backrest tube, Each armrest assembly is fixed to the seat assembly by armrest support piece, and the front end of the seat assembly is connected to the front wheel by a front fork connection assembly. The rear end of the seat assembly is connected to the rear wheel through a rear frame, and a mating pedal is provided at the front fork connection assembly, an auxiliary wheel for cooperation is provided at the rear wheel.

2. The electric wheelchair DYYJBHD20 according to claim 1, characterized in that the seat assembly is connected to the motor fixing bracket through a second rotating shaft, and the motor fixing bracket connected to the rear frame through the first shaft.

3. The electric wheelchair DYYJBHD20 according to claim 2, characterized in that the rear frame is respectively connected to the left connecting piece and the right connecting piece through a third rotating shaft, The rear frame is connected to the backrest tube through a fourth rotation shaft.

4. The electric wheelchair DYYJBHD20 according to claim 3, characterized in that the backrest tube, rear frame, left connecting piece, right connecting piece, seat assembly, the motor fixing bracket, the armrest assembly, the armrest support piece, the front fork connection assembly, and the foot pedal are all made of carbon fiber.

5. The electric wheelchair DYYJBHD20 according to claim 1, characterized in that the backrest tube is connected to the seat assembly through a fifth rotation shaft, and the backrest tube is connected to the armrest component through a sixth rotation shaft; the armrest support piece is connected to the armrest component through a seventh rotation shaft, and the armrest support piece is connected to the seat component through an eighth rotation shaft.

6. The electric wheelchair DYYJBHD20 according to claim 1, characterized in that the front fork connection assembly is connected to the seat assembly through a ninth rotation shaft, and the front fork connection assembly is connected to the left connecting piece and the right connecting piece through tenth rotating shaft respectively.

7. The electric wheelchair DYYJBHD20 according to claim 1, characterized in that the foot pedal is connected to the front fork connection assembly through a twelfth shaft to realize the foot pedal flip up and down.

8. The electric wheelchair DYYJBHD20 according to claim 1, characterized in that: a handle lock and a locking screw are provided on the seat assembly for use, and the handle lock is connected to the seat assembly through the eleventh rotating shaft to realize vertical rotation, and the locking screw is used to lock or unlock.
